(19) United States
(12) Patent Application Publication
(10) Pub. No.: US 2005/0257167 A1
(43) Pub. Date: Nov. 17, 2005

(54) Embedded Web dialog

(75) Inventors: John Howard Fraleigh JR., Cary, NC (US); Robert Leah, Cary, NC (US); Kenneth James Parzygnat, Apex, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/843,090

(22) Filed: May 11, 2004

(51) Int. Cl. G06F 3/00; G06F 17/21

(52) U.S. Cl. 715/809; 715/808; 715/843; 715/513; 715/760

(57) ABSTRACT

A modal dialog is embedded within a Web application page. Because the dialog interface is presented within the current user interface component, the user does not lose the context for the information required for the dialog. The dialog interface is presented directly inline with the rest of the user interface on the page.

### BACKGROUND OF THE INVENTION

1. Technical Field

The present invention relates to data processing and, in particular, to presenting dialog interfaces associated with Web content. Still more particularly, the present invention provides a method, apparatus, and program for embedding modal dialogs within Web documents.

2. Description of Related Art

A dialog, also known as a dialog box or dialog window, is an interface that is presented on screen when input is required from a user or to display suggestions, warnings, status information, etc. A dialog may be presented when a user selects a menu option, for example. A dialog may provide current status or available options for a particular feature in a program. A dialog is usually modal, meaning the dialog window takes over all input focus. The user typically must select an “OK” or “Cancel” control to exit the dialog interface and continue working with the application.

Web-based applications are applications that use structured documents, such as HyperText Markup Language (HTML) documents, to present the interface elements. Scripts, applets, and servelts, for example, may be used to provide the functionality of the application. However, currently there is no cross-browser way to display a modal dialog in Web-based applications.

The common solution is to show the dialog interface in another browser window, which is not modal. Therefore, when getting information from users, it is possible for dialogs to be lost behind the browser. Conversely, a dialog may be presented in a new browser window that covers the application interface. Thus, the user loses the context of the dialog and may have to switch back-and-forth between the application browser window and the dialog browser window to complete the dialog.

Another solution is to replace the content of the application page with a dialog page. This solution may present a modal dialog, with respect to the Web browser at least. However, this results in the context information in the application being lost. The user must complete the dialog without the benefit of the information in the application.

### SUMMARY OF THE INVENTION

The present invention recognizes the disadvantages of the prior art and provides a method, apparatus, and program for embedding modal dialogs inline within Web application pages. Because the dialog interface is presented within the current user interface component, the user does not lose the context for the information required for the dialog. The present invention presents the dialog interface directly inline with the rest of the user interface on the page. The dialog cannot be moved to the background or hidden any other way.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system is shown in which the present invention may be implemented;

FIG. 4, a diagram illustrating a client/server configuration in accordance with an exemplary embodiment of the present invention;

FIG. 5A illustrates an example screen of display in accordance with a preferred embodiment of the present invention;

FIG. 5B illustrates an example of a conventional dialog box;

FIG. 6 illustrates an example screen of display including an embedded dialog in accordance with a preferred embodiment of the present invention;

FIG. 7 is a flowchart illustrating the operation of a client in accordance with an exemplary embodiment of the present invention; and

FIG. 8 is a flowchart illustrating the operation of a server in accordance with an exemplary embodiment of the present invention.

### DETAILED DESCRIPTION OF THE PREFERRED EMBODIMENT

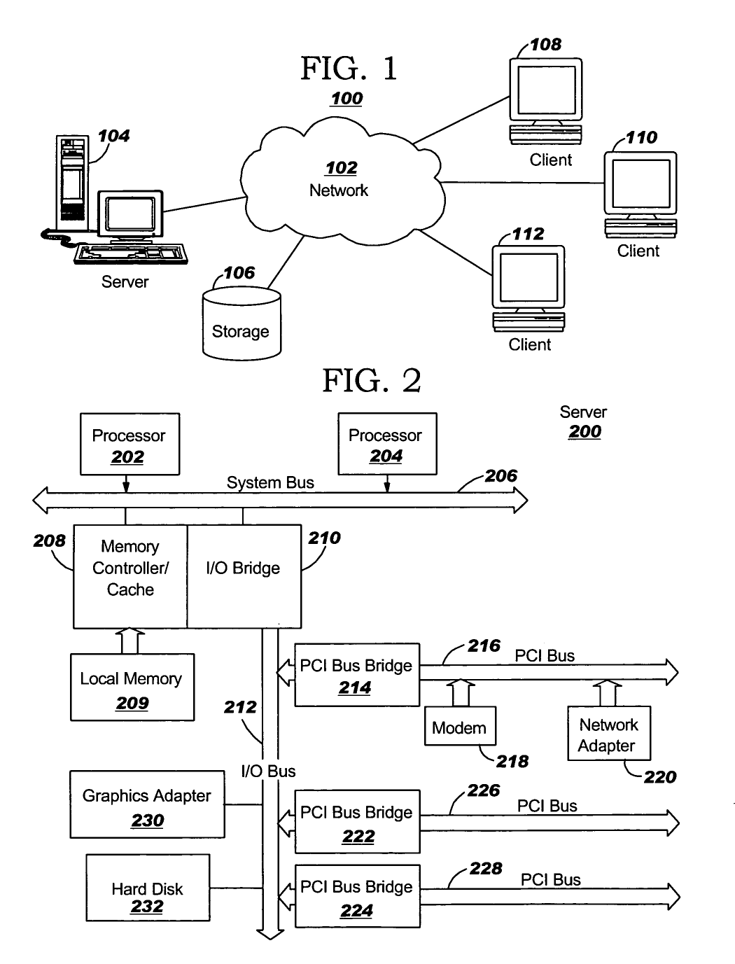

The present invention provides a method, apparatus and computer program product for embedding modal dialogs within Web documents. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

More particularly, server 104 may provide Web-based applications to clients 108-112. These Web-based applications may include dialogs. In accordance with a preferred embodiment of the present invention, server 104 builds each page of the application and returns the page to the requesting client. When a request indicates that a dialog is to be open, server 104 rebuilds the current page and embeds the dialog inline in the page. When the dialog is completed, e.g. when the user selects an “OK” or “Cancel” control in the dialog, server 104 receives user input from the dialog and rebuilds the current page based on the user input without the dialog interface, unless the result of one dialog requires another dialog to be created.

A dialog may be embedded, for example, using a scripting language, such as the JavaScript™ scripting language. A dialog may be associated with the entire page or, alternatively, a component within a page, such as, for example, an image, a frame, or a table. For instance, a user may resize an image using a dialog. In this example, a request will be sent from the client to the server, the server will rebuild the page with a dialog associated with the image, and the server will return the rebuilt page to the requesting client. When the rebuilt page is rendered at the client, the user may then resize the image by entering values in the dialog, for example, and select a control to complete the dialog. This will result in another request for the current page that includes the values entered in the dialog. Using these values, the server may then rebuild the page with the image resized.

Alternatively, a server may preload a page with all possible dialogs embedded in the page. These dialogs may be hidden or suppressed until selected by the user. However, this may result in longer loading times and a completed dialog may still require the page to be regenerated at the server.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX®) operating system or LINUX operating system.

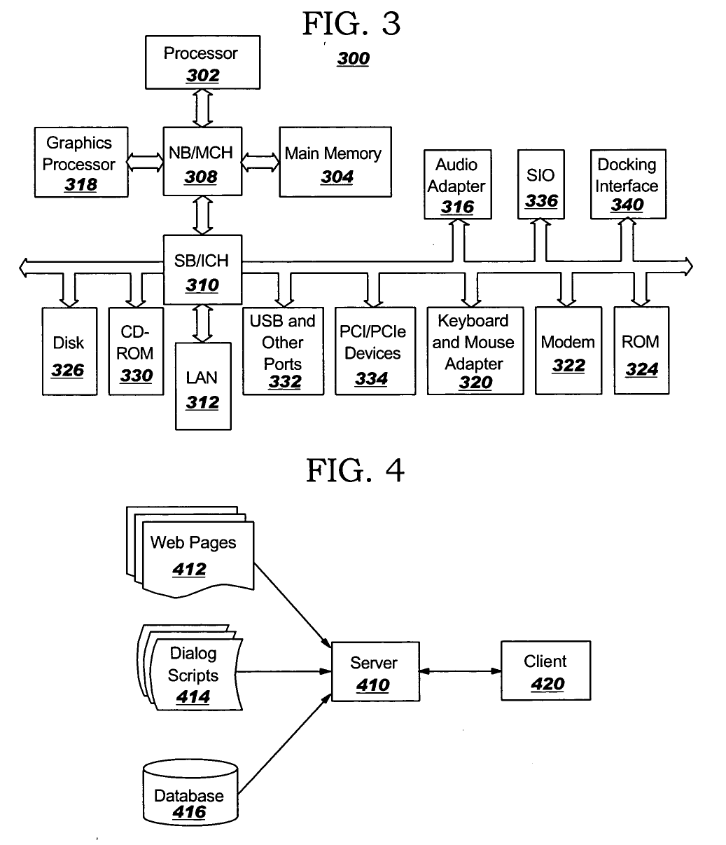

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as the Windows® XP operating system, which is available from Microsoft Corporation. An object oriented programming system such as the Java™ programming system may run in conjunction with the operating system and provides calls to the operating system from Java™ programs or applications executing on data processing system 300. “JAVA” is a trademark of Sun Microsystems, Inc. Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

With reference to FIG. 4, a diagram illustrating a client/server configuration in accordance with an exemplary embodiment of the present invention. Client 420 requests pages of a Web-based application through, for example, HyperText Transport Protocol (HTTP) “get” requests. Requests are received at server 410, which builds pages of the Web-based application and returns the pages to client 420.

Application pages may simply be Web pages, such as Web pages 412, or may be dynamically generated pages including dynamic content, such as from database 416 or servlets. For example, Web pages 412 may include JavaServer Pages™, which is an extension to the Java™ servlet technology from Sun Microsystems that provides a simple programming vehicle for displaying dynamic content on a Web page. A JavaServer Page™ (JSP™) is an HTML page with embedded Java source code that is executed in the Web server or application server. The HTML provides the page layout that will be returned to the Web browser at the client, and the Java™ code provides the processing.

A given application page may include a control for opening a dialog interface. For example, a page that displays a database table may include a hyperlink or button that may be selected to open a dialog for sorting the table. When an application page is rendered at client 420 and the user selects the control, a request is sent from client 420 to server 410. The request may be an identifier or address, such as a uniform resource locator (URL), for the current page with an indicator of the dialog to be included.

Server 410 parses each request and, if the request includes a dialog indicator or identifier, server 410 builds a response page using the current page from Web pages 412, including data from database 416, if necessary, and embeds a dialog in the page by inserting a script from dialog scripts 414. As discussed above, Web pages 412 may be simple HTML pages, extensible Markup Language (XML) documents, or JavaServer Pages™. Database 416 may be, for example, a relational database. Dialog scripts use, for example, the JavaScript™ scripting language.

While the depicted example embeds dialog interfaces as scripts, a dialog may take other forms within the scope of the present invention. For example, a dialog interface may be embedded as HTML, as XML, a Common Gateway Interface (CGI) script, or as a Java™ applet. As another example, dialog interfaces may be embedded within an application page using Struts and Tiles or other techniques.

The return page is then rendered on client 420 and the user may then enter information in the dialog. A typical dialog box includes a completion control, such as an “OK” button, and cancel control, such as a “Cancel” button. When the user is finished entering information, the user selects the completion control. However, if the user decides to cancel the dialog, the user selects the cancel control. An HTTP request is then sent back to server 410, along with an indication that he dialog is completed or canceled and any data entered into the dialog. Server 410 parses each request and, if the request includes a completed or canceled indicator, server 410 then rebuilds the application page accordingly.

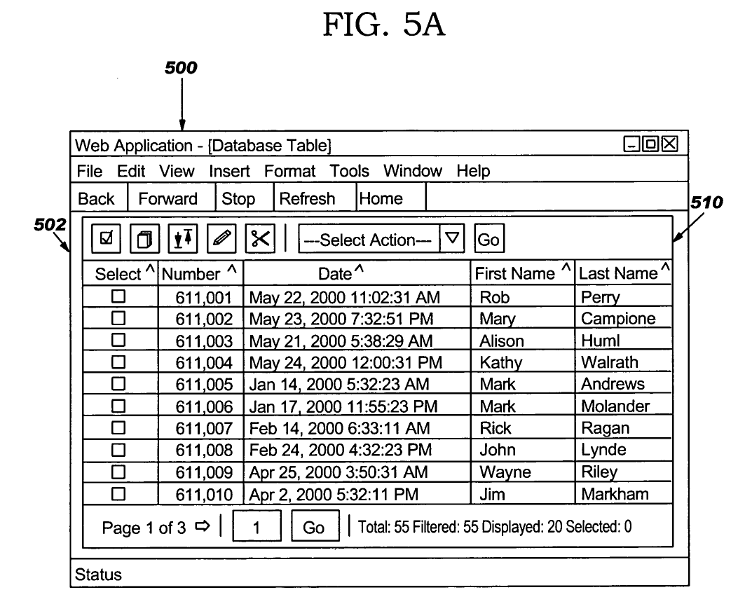

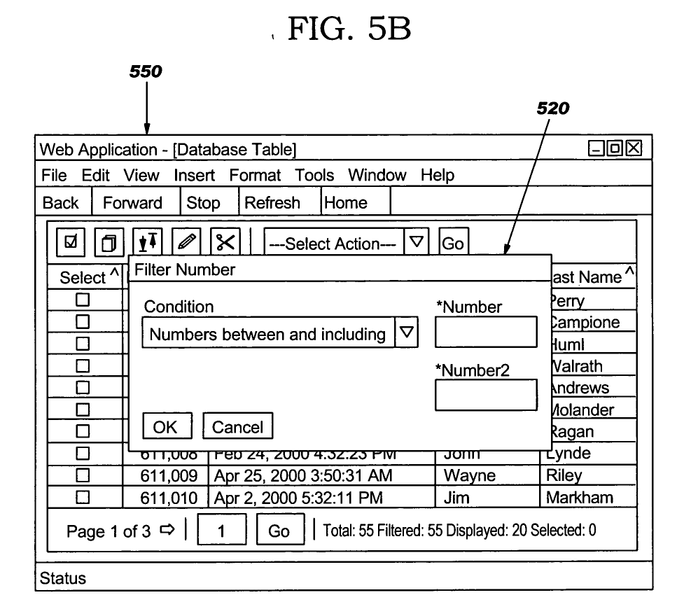

FIG. 5A illustrates an example screen of display in accordance with a preferred embodiment of the present invention. Window 500 is, for example, a Web client window, such as a Web browser. Window 500 includes display area 502 that displays Web content, such as a Web-based application page. In the depicted example, display area 502 displays database table 510 with user interface elements. In the illustrated example, the column headers in table 510 include a control for opening a dialog interface. For example, a user may select the control in the “Number” column to sort the table by number.

FIG. 5B illustrates an example of a conventional dialog box. Window 550 is, for example, a Web client window, such as a Web browser, displaying a Web-based application page. Dialog box 520 is opened and presented over window 550. As seen in the depicted example, dialog box 520 covers the content displayed within window 550. Therefore, a user entering data into dialog box 520 loses the context for the dialog.

Furthermore, dialog box 520 may simply be another Web browser window. Since such a dialog interface is not modal, meaning the dialog window does not take over all focus, the user may simply give focus to another window. This may result in dialog box 520 being hidden from view. In fact, a user may simply forget that dialog boxes are open and open more dialog boxes, leaving several open at a time.

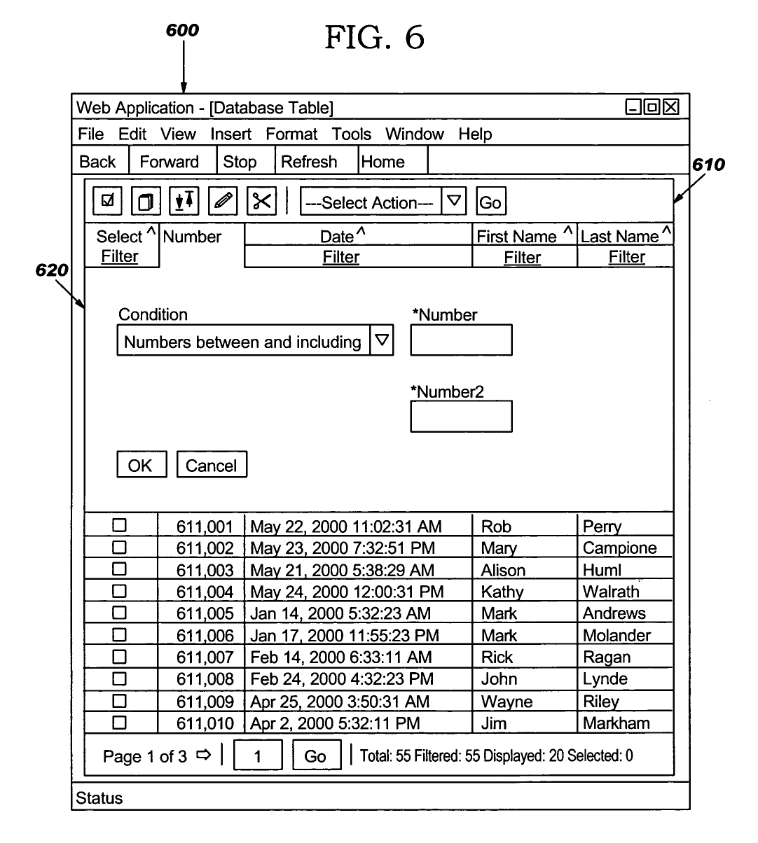

FIG. 6 illustrates an example screen of display including an embedded dialog in accordance with a preferred embodiment of the present invention. Window 600 is, for example, a Web client window, such as a Web browser, displaying a Web-based application page. In this example, the Web-based application includes database table 610 with user interface elements. The database table has embedded dialog 620, which is displayed in association with the “Number” column in database table 610.

Since dialog 620 is embedded within the Web page or, in this case, within a component of the page, the context for the dialog is not lost. The dialog may be modal with respect to the Web-based application. That is, the dialog may be the only component on the page that has focus. Alternatively, the user may be allowed to interact with other elements on the page. For example, the user may be allowed to change pages within table 610 while keeping dialog 620 active.

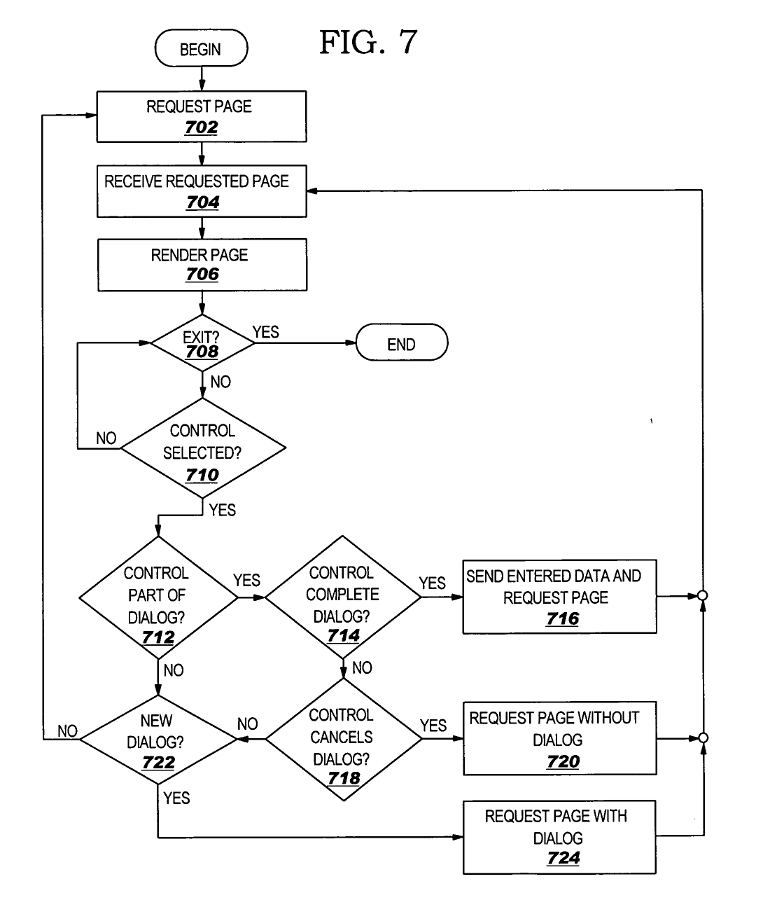

FIG. 7 is a flowchart illustrating the operation of a client in accordance with an exemplary embodiment of the present invention. The process begins and the client requests a page (block 702). The client receives the requested page (block 704) and renders the page (block 706). A determination is made as to whether an exit condition exists (block 708). An exit condition may exist when the Web client is closed, for example. If an exit condition exists, the process ends.

If an exit condition does not exist in block 708, a determination is made as to whether a control is selected (block 710). If a control is not selected, the process returns to block 708 to determine whether an exit condition exists. If, however, a control is selected in block 710, a determination is made as to whether the control is part of a dialog (block 712). If the control is part of a dialog, a determination is made as to whether the control is a complete control (block 714). A complete control indicates that entry of data is complete. If the control is a complete control, the process sends the entered data and a request for the page to the server (block 716). Then, the process returns to block 704 where the client receives the requested page.

If the control is not a complete control in block 714, a determination is made as to whether the control cancels the dialog (block 718). If the control cancels the dialog, the process request the page without the dialog (block 720) and returns to block 704 where the client receives the requested page.

If the control does not cancel the dialog in block 718 or the control is not part of a dialog in block 712, a determination is made as to whether the control requests a new dialog (block 722). If the control request a new dialog, the process requests the page with the new dialog (block 724) and returns to block 704 where the client receives the requested page. Otherwise, the process returns to block 702 where the client requests a new page.

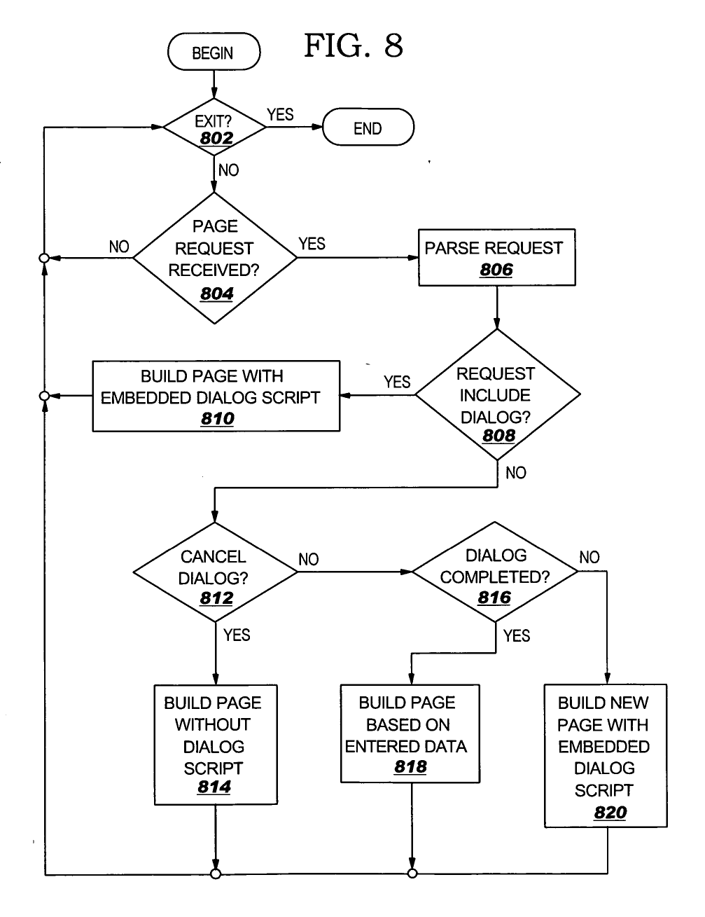

FIG. 8 is a flowchart illustrating the operation of a server in accordance with an exemplary embodiment of the present invention. The process begins and a determination is made as to whether an exit condition exists (block 802). An exit condition may exist when the Web server is closed, for example. If an exit condition exists, the process ends.

If an exit condition does not exist in block 802, a determination is made as to whether a page request is received (block 804). If a page requests is not received, the process returns to block 802 to determine whether an exit condition exists. If a page request is received in block 804, the process parses the page request (block 806) and a determination is made as to whether the request includes a dialog indicator (block 808).

If the request includes a dialog indicator, the process builds the page with an embedded dialog script corresponding to the dialog indicator (block 810). Then, the process returns to block 802 to determine whether an exit condition exists.

If the request does not include a dialog indicator in block 808, a determination is made as to whether the request includes a cancel dialog indicator (block 812). If the request includes a cancel dialog indicator, the process builds the page without the dialog script (block 814) and returns to block 802 to determine whether an exit condition exists.

If the request does not include a cancel dialog indicator in block 812, a determination is made as to whether the request includes a dialog complete indicator (block 816). If the request includes a dialog complete indicator, the process builds the page based on the data entered in the dialog (block 818) and returns to block 802 to determine whether an exit condition exists.

If the request does not include a dialog complete indicator in block 816, then the request originates from a control outside the dialog. As such, the process builds a new page with the embedded dialog script (block 820) and returns to block 802 to determine whether an exit condition exists. Alternatively, if the request does not include a dialog complete indicator in block 816, then the request may be unrelated to the Web-based application and the process may build an entirely new page without an embedded dialog in block 820.

Thus, the present invention solves the disadvantages of the prior art by providing a mechanism for embedding modal dialogs inline within Web application pages. Because the dialog interface is presented within the current user interface component, the user does not lose the context for the information required for the dialog. The present invention presents the dialog interface directly inline with the rest of the user interface on the page. The dialog cannot be moved to the background or hidden any other way.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for embedding a dialog in a Web-based application page, the method comprising:
receiving a request for a page from a client;
building the page;
determining whether the page is to include a dialog interface;
if the page is to include a dialog interface, embedding a dialog interface within the page to form a modified page; and
returning the modified page to the client.

2. The method of claim 1, further comprising:
if the page is not to include a dialog interface, returning the page to the client, wherein the page includes at least one control associated with a request for the page with an embedded dialog interface.

3. The method of claim 1, wherein determining whether the page is to include a dialog interface includes:
parsing the request; and
identifying a dialog indicator in the request.

4. The method of claim 1, wherein the dialog interface is embedded as a script.

5. The method of claim 1, further comprising:
receiving a subsequent request for the page from the client, wherein the subsequent request includes data entered into the dialog interface;
building a subsequent page based on the data; and
returning the subsequent page to the client.

6. The method of claim 1, further comprising:
receiving a subsequent request for the page from the client, wherein the subsequent request indicates that the dialog interface is to be canceled;
building a subsequent page without an embedded dialog interface; and
returning the subsequent page to the client.

7. A method for managing a Web-based application page, the method comprising:
receiving an application page from a server, wherein the application page includes a control associated with a request for the application page with an embedded dialog interface;
responsive to activation of the control, sending the request for the application page with an embedded dialog interface;
receiving the application page with a dialog interface embedded within the application page; and
presenting the application page with the embedded dialog interface.

8. The method of claim 7, wherein the embedded dialog interface includes at least one data field and a completion control.

9. The method of claim 8, further comprising:
responsive to a user entering data into the at least one data field and activating the completion control, sending a subsequent request for the application page to the server, wherein the subsequent request includes the data entered into the at least one data field.

10. The method of claim 9, wherein the subsequent request includes a uniform resource locator.

11. The method of claim 7, wherein the embedded dialog interface includes a cancel control.

12. The method of claim 11, further comprising:
responsive to a user activating the cancel control, sending a subsequent request for the application page to the server, wherein the subsequent request indicates that the dialog interface is to be canceled.

13. The method of claim 12, wherein the subsequent request includes a uniform resource locator.

14. An apparatus for embedding a dialog in a Web-based application page, the apparatus comprising:
means for receiving a request for a page from a client;
means for building the page;
means for determining whether the page is to include a dialog interface;
means for embedding a dialog interface within the page to form a modified page if the page is to include a dialog interface; and
means for returning the modified page to the client.

15. An apparatus for managing a Web-based application page, the apparatus comprising:
means for receiving an application page from a server, wherein the application page includes a control associated with a request for the application page with an embedded dialog interface;
means, responsive to activation of the control, for sending the request for the application page with an embedded dialog interface;
means for receiving the application page with a dialog interface embedded within the application page; and
means for presenting the application page with the embedded dialog interface.

16. A computer program product, in a computer readable medium, for embedding a dialog in a Web-based application page, the computer program product comprising:
instructions for receiving a request for a page from a client;
instructions for building the page;
instructions for determining whether the page is to include a dialog interface;
instructions for embedding a dialog interface within the page to form a modified page if the page is to include a dialog interface; and
instructions for returning the modified page to the client.

17. The computer program product of claim 16, wherein the instructions for determining whether the page is to include a dialog interface includes:
instructions for parsing the request; and
instructions for identifying a dialog indicator in the request.

18. The computer program product of claim 16, wherein the dialog interface is embedded as a script.

19. A computer program product, in a computer readable medium, for managing a Web-based application page, the computer program product comprising:
instructions for receiving an application page from a server, wherein the application page includes a control associated with a request for the application page with an embedded dialog interface;
instructions, responsive to activation of the control, for sending the request for the application page with an embedded dialog interface;
instructions for receiving the application page with a dialog interface embedded within the application page; and
instructions for presenting the application page with the embedded dialog interface.

20. The computer program product of claim 19, wherein the embedded dialog interface includes at least one data field and a completion control.

21. The computer program product of claim 20, further comprising:
instructions, responsive to a user entering data into the at least one data field and activating the completion control, for sending a subsequent request for the application page to the server, wherein the subsequent request includes the data entered into the at least one data field.

22. The computer program product of claim 19, wherein the embedded dialog interface includes a cancel control.

23. The computer program product of claim 22, further comprising:
instructions, responsive to a user activating the cancel control, for sending a subsequent request for the application page to the server, wherein the subsequent request indicates that the dialog interface is to be canceled.
